(19) United States
(12) Patent Application Publication
(10) Pub. No.: US 2012/0311868 A1
(43) Pub. Date: Dec. 13, 2012

(54) Feedback Spoon with Wireless Connectivity

(76) Inventor: Shai Cohen, Brooklyn, NY (US)

(21) Appl. No.: 13/158,088

(22) Filed: Jun. 10, 2011

(51) Int. Cl. A47G 21/00; G09B 19/24

(52) U.S. Cl. 30/123; 434/260

(57) ABSTRACT

Embodiments of the disclosed technology comprise a gripping spoon or other utensil with an electrode on each of the working portion and the handle. Upon making contact with each electrode, a positive reward is given in the form of a light or sound (such as music) either on the spoon itself or on a separate device which receives a transmission indicating that the circuit has been completed. As such, the utensil, such as a fork or spoon, may comprise a transmitter therein. Further, the working end of the utensil, in embodiments of the disclosed technology, has insulation or a non-conductive portion on the edges of the working end. In a spoon, this is in the form of insulation near the edges, on both the top and bottom sides. In a fork, this may involve insulation of the entire outer prongs and tips of the prongs. This forces the child or other user of the utensil to place the utensil in his or her mouth, rather than just touch the tip.

### FIELD OF THE DISCLOSED TECHNOLOGY

The disclosed technology relates generally to utensils and more specifically to spoons.

### BACKGROUND OF THE DISCLOSED TECHNOLOGY

Some babies and toddlers desire to do things like an adult as soon as possible and grasp at the spoon that is feeding them before they are able to properly manipulate it. These children need to be held back, so the food can enter their mouths instead of landing on the high chair. Other children insist on being fully pampered and refuse to grab at the spoon even when it might mean going without food. These children make some noises with wide open mouths and do everything short of pointing where they want you to put the spoon for them. Once babies and toddlers progress a little more and are ready to hold the spoon, we want to teach them to hold the spoon properly. In some cases, we just want to get them to hold the spoon and learn to eat by themselves, rather than insist on having the parent or caretaker feeding them. As the child is being trained to hold the spoon, it is desirable for him or her to hold it correctly.

One device known in the prior art which accomplishes some of these aims is disclosed in U.S. Pat. No. 6,359,559 to Rudell et al. The device of Rudell is a toy which lights up upon a first and second electrode being contacted. Thus, a toddler might press a button on the side of a popsicle holder and put his/her tongue on it to cause a light to go on. FIG. 15 of Rudell shows a spoon with an electrode inside, and another electrode at the back end of the handle.

What is needed in the art is to turn the spoon into an educational tool which aids a child in holding it, as well as other utensils, in a proper way. What is further needed is a way to entice children who prefer not to use a spoon to overcome the resistance.

### SUMMARY OF THE DISCLOSED TECHNOLOGY

An object of the disclosed technology is to provide a utensil, such as a spoon, which is fun to use and trains a child to use the spoon properly.

A further object of the disclosed technology is to transmit proper utensil usage data to a remote device for storage.

An eating utensil of embodiments of the disclosed technology has a working portion, with a metal portion or section thereof acting as a first electrode, a second metallic electrode on a gripping portion of a handle of the utensil, and a wireless transmitter housed within the utensil which transmits data in response to a circuit being formed between the first and second electrodes.

The working portion of the utensil, in an embodiment of the disclosed technology, has non-conductive insulating material at edges of thereof. In some embodiments, the edges are outer prongs and/or tips of the prongs of a fork, whereas in others, the edges are edges of a spoon.

The transmitter, in embodiments of the disclosed technology, transmits only when the circuit (between the electrodes) is formed. In another embodiment, it transmits continuously and when the circuit is formed, data understood by a receiver to be representative of the fact that a circuit has formed, is transmitted. A receiver of a transmission made by the transmitter stores time data related to when the circuit was formed, in embodiments. The receiver may also exhibit (emit or play) music upon the circuit being formed.

A metallic eating utensil, in an embodiment of the disclosed technology, may have a working portion acting as a first electrode, insulation around edges of the metallic working portion, a non-metallic handle portion with a section thereof designated for gripping, and a second electrode on the gripping portion. A circuit is formed upon contact with the first and second electrodes.

The working portion of the eating utensil may be a spoon with insulation covering an entire top and entire bottom portion of the spoon, except for a center region of the top and said bottom. Or, if the utensil is a fork with prongs, the insulation may cover the two outer prongs, and/or the tips of the prongs.

The metallic eating utensil may also have a light which is lit upon formation of the circuit. The light may be situated on a foldable picture which unfolds when the circuit is formed. The foldable picture may further emit sound when the circuit is formed.

The metallic eating utensil may further have a transmitter configured to transmit data upon the circuit being formed, the transmitter selected from the group consisting of short-range radio transmitters, visible light transmitters, and infrared transmitters. A corresponding receiver interprets the pulses of light (visible or infrared) or radio signals.

A spoon, in another embodiment of the disclosed technology, has gripping flanges on a handle portion thereof, situated in a gripping area. The spoon also has an electrode on the handle portion situated within the gripping area (the area of the spoon handle covered by the hand when the spoon is held correctly). A working end of the spoon acts as a second electrode having a concave upper portion and convex lower portion. Insulation around the edges of the concave and the convex portions of the working end of the spoon results in a conductive portion of the second electrode consisting of an inner portion of both the convex and concave portions of the working end of the spoon. The spoon also has a wireless transmitter housed within the spoon, a light connected to the handle of the spoon, and a light attached to a wireless receiver (display screen, LED light, LCD light, or the like), wherein, upon making contact with each of the electrodes, at least one of the lights becomes illuminated.

Methods of training a child to use a utensil properly are also disclosed, with reference to each of the above embodiments.

Further details are set forth in the detailed description below.

### BRIEF DESCRIPTION OF THE DRAWINGS

FIG. 1A shows a perspective view of an insulated training spoon of an embodiment of the disclosed technology.

FIG. 1B shows a perspective view of an insulated training fork of an embodiment of the disclosed technology.

FIG. 2 shows a side diagrammatic view of a training spoon placed in the mouth of a user.

FIG. 3 shows a perspective view of an embodiment of the training spoon with a vertically extending lightable plate.

FIG. 4 shows a partially cutaway perspective view of an embodiment of the training spoon with wireless transmitter.

### DETAILED DESCRIPTION OF EMBODIMENTS OF THE DISCLOSED TECHNOLOGY

Embodiments of the disclosed technology comprise a gripping spoon or other utensil with an electrode on each of the working portions and the handle. Upon making contact with each electrode, a positive reward is given in the form of a light or sound (such as music) either on the spoon itself or on a separate device which receives a transmission indicating that the circuit has been completed. As such, the utensil, such as a fork or spoon, may comprise a transmitter therein. Further, the working end of the utensil, in embodiments of the disclosed technology, has insulation or a non-conductive portion on the edges of the working end. In a spoon, this is in the form of insulation near the edges, on both the top and bottom sides. In a fork, this may involve insulation of the entire outer prongs and tips of the prongs. This forces the child using the utensil to place it in his or her mouth, rather than just touch the tip.

Embodiments of the disclosed technology will become clearer in view of the following description of the Figures.

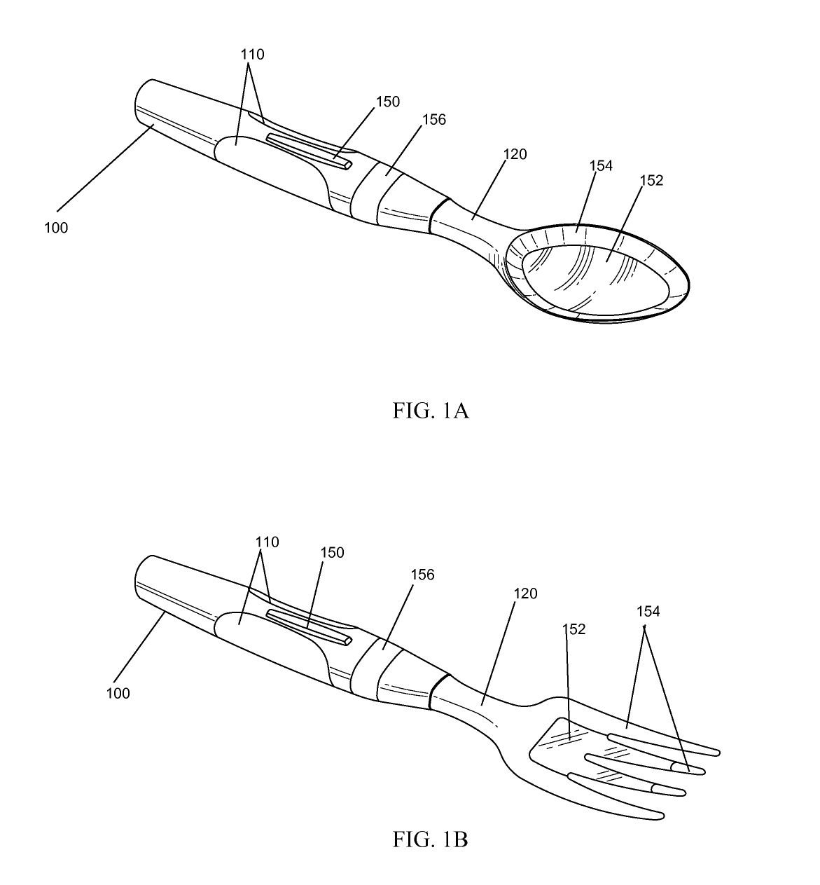

FIG. 1A shows a perspective view of an insulated training spoon of an embodiment of the disclosed technology. The insulated training spoon has an elongated handle portion 100 with training grips 110. The grips are indentations or bulges in or out from the surface of the handle portion 100 and allow a person (such as a child) to feel which part of the spoon is being grabbed. The training grips 110 direct a user's hand to the appropriate place, as grasping at this location is generally made to be comfortable. In this manner, a user is taught to “properly” hold a spoon. “Properly” is defined as in a socially acceptable or ergonomic manner. A gripping portion is defined as the place on the utensil which is designed for engagement with a user's hand and includes at least part of the training grips 110.

A metallic contact point or electrode 150 is placed within the area defined by the gripping portion. An additional electrode is placed within the head of the spoon/working portion 152. As is known in the art, the working portion of a spoon is a concave, generally ovoid, portion which supports liquid or food products being placed into a mouth. To further ensure that the spoon is used properly, insulation 154 is placed around the edges of the working portion 152 of the spoon, in embodiments of the disclosed technology. The insulation may cover the edges (where the top and bottom of the working portion meet) and inwards, such as 2 mm, 5 mm, 10 mm, 15 mm, or 20 mm. Electrode 110 and electrode 152 (the working portion of the spoon) are part of a circuit which is connected via electrical connectivity when a person touches both items. When the person completes the circuit by touching electrode 150 (accomplished while a hand covers grips 110, in embodiments) and working portion 152 (such as by putting the spoon in one's mouth) a light 156 lights up to provide positive re-enforcement for a user, that he is both holding the spoon and eating correctly. Stem 120 connects the working portion of the utensil to the handle section thereof. The stem portion 120 may be part of the electrode of the working portion or may be insulated with an electrical conductor (such as a wire or by being partially or fully cast out of metal) passing therein. In the embodiment shown in FIG. 1A, the stem is not insulated.

FIG. 1B shows a perspective view of an insulated training fork of an embodiment of the disclosed technology. Elements which perform functions similar to those of FIG. 1A have the same labels. Thus, here, working portion 152 is the working portion of a fork, such as a three- or four-pronged fork. The edges 154 have insulation, such as starting from the point where top and bottom sides of the fork meet, and going inwards from between 2 and 20 mm or more from the side edges and/or top edges. In this manner, a child cannot just touch the fork (or spoon of FIG. 1A) to his or her lips and create a positive reaction from light 156. The fork has to actually enter the mouth. In the embodiment shown in FIG. 1B, the stem is insulated. Note also that when the utensil is a fork (or any other pronged utensil), the outer prongs may be completely covered with insulation.

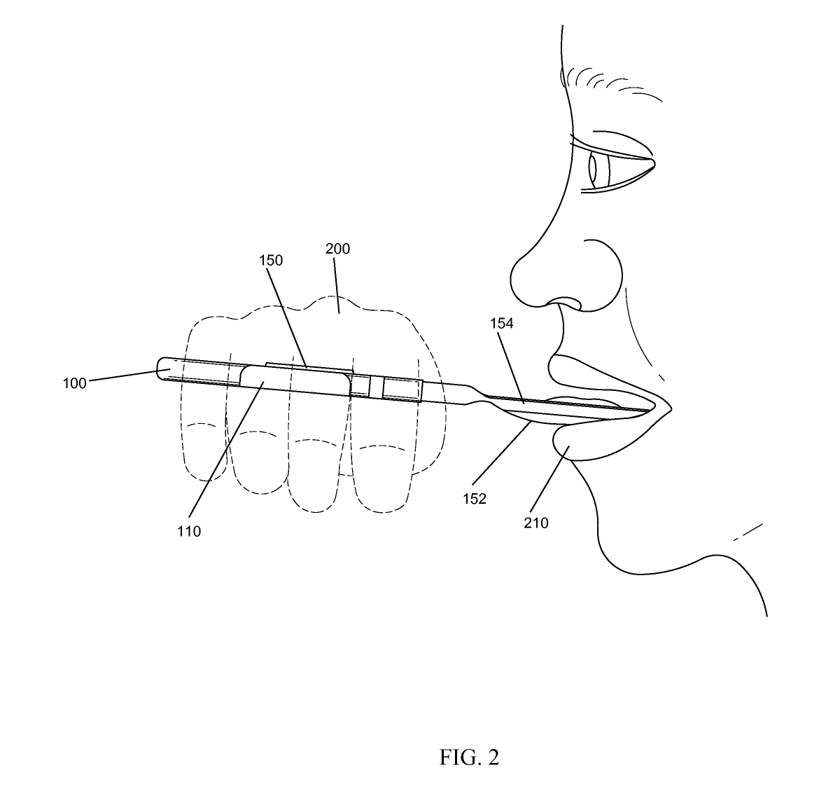

FIG. 2 shows a side diagrammatic view of a training spoon placed in the mouth of a user. The working end of the utensil, as shown in FIG. 2, is making electrical contact with the bottom lip 210 of the user. That is, the spoon is in the child's mouth. Food (unlabeled in the Figure) is held within the spoon and the person is clutching the elongated handle portion 100, covering part of the gripping portion which comprises the electrode 150. In this manner, electrical connectivity extends from electrode 150, through the hand, arm, and torso of the user, up through the neck and head, and via the lips 210 (or the tongue, teeth, interior of the mouth, and other parts of the mouth anatomy) to the second electrode 152. The insulation 154 ensures that the electrical connectivity is only made when the spoon is placed at least as far into the mouth so that an interior portion of the spoon (or other utensil) is in the mouth when used properly. The light, or other indicator, is activated only when such an interior portion (which is defined as the working portion of a utensil excluding insulated/non-conductive edges) is touching a portion of the body of a user. With adult supervision, a child should be using his/her spoon for eating, thus the portion of the body of a user is the lips or inside of a mouth. As such, the light (or other indicators, as will be described in the figures below) is activated, in a method of use, only when the interior portion of a body touches an interior portion of a working end of a spoon. In this manner, the indicator provides positive re-enforcement for proper eating.

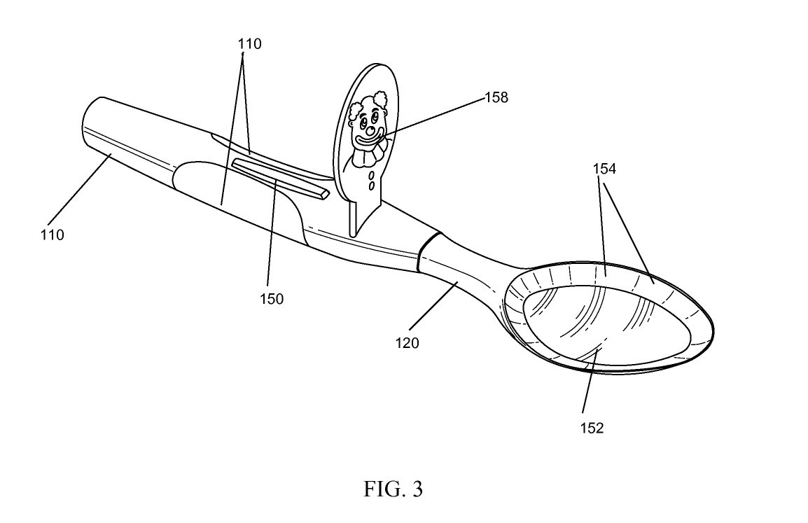

FIG. 3 shows a perspective view of an embodiment of the training spoon with a vertically extending lightable plate. In this embodiment, the indicator is an icon, picture, or FIG. 158 which lights up. Here, a clown is shown. Sound, such as a beep or music may also accompany the lighting up of the picture 158 and/or completion of the circuit between electrodes 150 and 152. The picture 158 may additionally fold down when not activated, and fold up when activated properly and dependent on the amount of current flowing between the electrodes. Thus, a better grip or fuller placement of the utensil in a mouth may result in a faster flip upwards, a brighter light, or more sound.

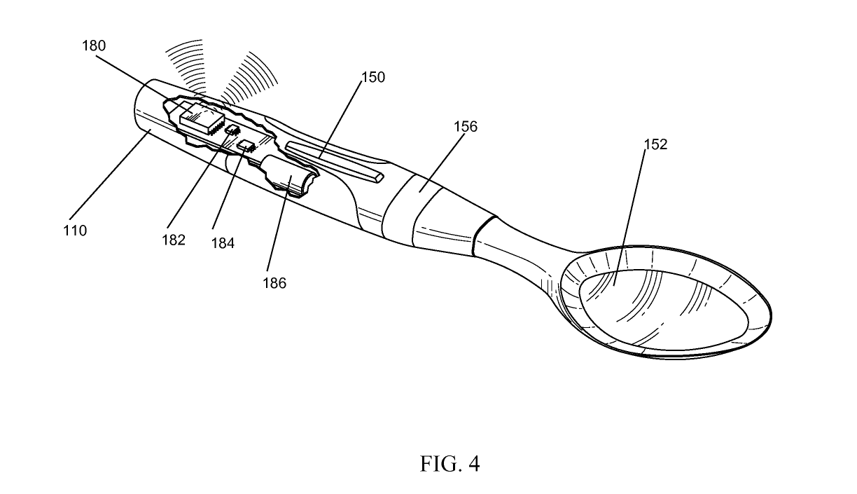

FIG. 4 shows a partially cutaway perspective view of an embodiment of the training spoon with wireless transmitter. Any utensil may be used with embodiments of FIG. 4, though a spoon is shown. Here, the electrical pathway created between electrodes 150 and 152 is similar to that of the prior figures, though additional circuitry is present. Further, the light 156 may also be present in the embodiment of FIG. 4, but is optional. A battery 186 (again, which may be present in other embodiments disclosed) powers the device, including a transmitter 180, storage device 182, and processor 184. The storage device 182 may be non-volatile memory which stores instructions to be carried out by the processor 184, which determines when contact is made between electrodes 150 and 152 by way of an electrical signal received to the processor, such as by powering on the processor (placed in series with the electrodes) and causing the transmitter to transmit a signal indicating that processor is powered/the electrodes are forming a circuit. Or, the processor may be connected to an electrical input which transmits a signal to the processor by way of a connection in parallel to the circuit between the electrodes 150/152.

The transmitter may transmit via any wireless transmission method known in the art, such as Bluetooth, infrared, Near Field Communication, 802.11 wireless networking, and other radio transmission or light signaling methods. A receiver on the other end, may be a device such as a personal digital assistant, cellular phone, personal computer, laptop computer, stand-alone receiver, radio/music player, and so forth. Upon one of these devices receiving a transmitted signal from the transmitter 180, the devices perform a predefined action. The transmission may be a pulse of data which may be transmitted as long as the circuit is complete between the electrodes (such as when the utensil is being held and used properly). The transmission may be a unique code to identify the utensil, such as when several children are eating with a number of such utensils. Each received transmission, indicating the completion of the circuit, may then be acted upon by the receiving device. The date, time, and length of use may be recorded to help track eating habits. A song, music, sounds, or lights may be exhibited on the receiving device.

While the disclosed technology has been taught with specific reference to the above embodiments, a person having ordinary skill in the art will recognize that changes can be made in form and detail without departing from the spirit and the scope of the disclosed technology. The described embodiments are to be considered in all respects only as illustrative and not restrictive. All changes that come within the meaning and range of equivalence of the claims are to be embraced within their scope. Combinations of any of the methods, systems, and devices described hereinabove are also contemplated and within the scope of the disclosed technology.

1. An eating utensil, comprising:
a working portion of said utensil comprising a metal section as a first electrode;
a second metallic electrode on a gripping portion of a handle of said utensil;
a wireless transmitter housed within said utensil which transmits data in response to a circuit being formed between said first and second electrodes.

2. The eating utensil of claim 1, wherein said working portion of said utensil comprises non-conductive insulating material at edges of said working portion.

3. The eating utensil of claim 2, wherein said edges comprise outer prongs of a fork.

4. The eating utensil of claim 2, wherein said edges comprise edges of a spoon.

5. The eating utensil of claim 1, wherein said transmitter transmits only when said circuit is formed.

6. The eating utensil of claim 1, wherein said transmitter transmits continuously and when said circuit is formed, data understood by a receiver to be representative of said formed circuit is transmitted.

7. The eating utensil of claim 1, wherein a receiver of a transmission made by said transmitter stores time data of said formed circuit.

8. The eating utensil of claim 1, wherein said receiver of a transmission made by said transmitter produces music upon said circuit being formed.

9. A metallic eating utensil, comprising:
a working portion of said metallic eating utensil acting as a first electrode;
insulation around edges of said metallic working portion;
a non-metallic handle portion with a portion thereof designated for gripping; and
a second electrode on said gripping portion; wherein a circuit is formed upon contact with said first and said second electrodes.

10. The metallic eating utensil of claim 9, wherein said working portion is a spoon and said insulation covers an entire top and entire bottom portion of said spoon, except for a center region of said top and said bottom.

11. The metallic eating utensil of claim 9, wherein said working portion is a pronged fork, and said insulation covers two outer prongs.

12. The metallic eating utensil of claim 11, wherein said insulation further covers tips of each prong.

13. The metallic eating utensil of claim 9, further comprising a light which is lit upon formation of said circuit.

14. The metallic eating utensil of claim 13, wherein said light is situated on a foldable picture which unfolds when said circuit is formed.

15. The metallic eating utensil of claim 14, wherein said foldable picture further emits sound when said circuit is formed.

16. The metallic eating utensil of claim 9, further comprising a transmitter, said transmitter configured to transmit data upon said circuit being formed.

17. The metallic eating utensil of claim 16, wherein said transmitter is selected from the group consisting of short-range radio transmitters, visible light transmitters, and infrared transmitters.

18. A spoon, comprising:
gripping flanges on a handle portion thereof, situated in a gripping area;
an electrode on said handle portion situated within said gripping area;
a working end of said spoon acting as a second electrode having a concave upper portion and convex lower portion;
insulation around the edges of said concave and said convex portions of said working end of said spoon resulting in a conductive portion of said second electrode consisting of an inner portion of both said convex and concave portions of said working end of said spoon;
a wireless transmitter housed within said spoon;
a light connected to said handle of said spoon;
a light attached to a wireless receiver;
wherein, upon making contact with each said electrode, at least one of said lights becomes illuminated.

19. A method of training a child to hold a spoon, utilizing the device of claim 18.

20. A method of training a child to hold a utensil, utilizing the device of claim 1.
